(19) United States
(12) Patent Application Publication
(10) Pub. No.: US 2010/0058250 A1
(43) Pub. Date: Mar. 4, 2010

(54) Editing numeric charts

(75) Inventors: Paul Stannard, Rancho Santa Fe, CA (US); Steven Niles, Fallbrook, CA (US); Joshua Platt, San Diego, CA (US)

Correspondence Address: TERRANCE A. MEADOR;INCAPLAW, 1050 ROSCRANS STREET, SUITE K, SAN DIEGO, CA, 92106, US

(73) Assignee: SmartDraw.com, San Diego, CA (US)

(21) Appl. No.: 12/231,147

(22) Filed: Aug. 28, 2008

(51) Int. Cl. G06F 3/048

(52) U.S. Cl. 715/856

(57) ABSTRACT

A computer-executed method for editing a numeric chart includes displaying a numeric chart having at least one object with a dimension representing a variable and positioning a cursor in the object. A numeric value of the variable is displayed near the object in response to positioning the cursor in the object. In response to receiving a command to change the value of the variable, the displayed value and the dimension are changed to correspond to the changed value. The chart may be edited by moving an element of the object with a cursor and presenting a readout of the value of the variable at or near the location of the cursor. The chart may be edited by changing a location of an element of the object in response to entry of a value in an entry field that is at least partly within the object.

### BACKGROUND

The field includes interactive graphics programs which manage the editing of numeric charts generated by a computer or processor.

A computer or processor may be programmed or constructed to execute or perform an interactive graphics process in which a computer- or processor-generated graphics output is provided in response to commands entered by a user. The interactive graphics process may be embodied, for example, as a drawing program, as application-specific hardware, or a combination thereof. The graphics output is a visual representation of something conceived by the user.

An interactive graphics process generates or draws a numeric chart as a visible diagram, map, model, or schematic composed of chart objects (such as bars, wedges, points, or lines) that represent values or magnitudes of variables (or parameters), and other chart symbols (such as axes, or perimeters) arranged to represent relationships among or between the variables. Examples of numeric charts include, without limitation, bar charts, pie charts, and line graphs.

In order to generate, maintain, and manage a numeric chart, the interactive graphics process maintains data for the chart in a storage structure that contains elements corresponding to variables represented in the chart. These elements have numeric values that establish the magnitudes of the variables. Examples of such storage structures include, without limitation, tables, trees, and lists. Typically, the interactive graphics process maintains a relationship between a numeric chart and a storage structure that enables a user to edit the chart by setting and changing the numeric values in the storage structure. In some instances, a user may be enabled to edit a numeric chart by way of a spreadsheet program. When the user enters, edits, or changes data in a spreadsheet, the data is exported to an editing function of an interactive graphics program, which correspondingly edits both the numeric chart and the storage structure. A database program may be similarly linked to the interactive graphics program to provide values for a numeric chart.

Numeric charts are important tools in many aspects of enterprise strategy and management, and interactive graphics programs have become very flexible from the user's standpoint. For example, the elements of numeric charts that represent numeric values—bars, wedges, line points—can be directly edited by a user to adjust or change the values. That is to say, bars can be stretched or shortened, pie wedges can be widened or narrowed, and line points can be moved to change numeric values while the controlling interactive graphics program tracks the edits and changes the values in the underlying data storage structures when commanded to do so by the user.

One mechanism by which the user of an interactive graphics program edits a numeric chart is a cursor. A cursor is a symbol on a display that indicates a point of reference with respect to which a command is executed or an action is taken. A cursor is moved and actuated on the display by user operation of a pointing device or a keyboard. For example, to stretch a bar in a bar chart, a cursor may be moved to the upper edge of the bar where it engages the edge and drags he edge upwardly to a new location above its initial location. The new location represents a larger value of the variable represented by the bar than that represented at the initial location. In this regard see U.S. Pat. No. 4,674,043, for example.

A user may need a degree of precision in editing numeric charts that is not currently provided by interactive graphics programs. For example, the user cannot ascertain the precise magnitude of a changed value while editing a graph object without reference to a separate object, such as a chart, or visual estimation of the height of the bar with respect to a vertical axis. Furthermore, the values represented in a numeric chart can only be edited by changing dimensional characteristics of the objects that represent variables, by changing the corresponding values in a table separate from the chart, or by way of a spreadsheet or database program.

A user of an interactive graphics program may, in some instances, require a more immediate understanding of the effect of an editing action on the magnitude or value of a variable represented in a numeric chart. Thus, a user may want to determine precisely and immediately where the top of a bar must be positioned in order to represent a specific value, without having to constantly shift attention between a table and the bar being edited. Furthermore, the user may desire to edit the chart in such a way as to determine the effect of a specific value on the appearance of the bar without moving a cursor in the chart or redirecting attention from the chart to a spreadsheet or database program.

### SUMMARY

A computer-executed method for editing a numeric chart includes displaying a numeric chart having at least one object with a dimension representing a variable and positioning a cursor in the object. A value of the variable is displayed at least partially within the object in response to positioning the cursor in the object. In response to receiving a command to change the value of the variable, the dimension is changed to correspond to the changed value.

Editing an object representing a variable in a numeric chart by moving an element of the object with a cursor includes presenting a readout of the value of the variable with the cursor, at the cursor, or near the location of the cursor.

Preferably, the value in the readout changes with a change in position of the element being edited with the cursor.

Editing an object representing a variable in a numeric chart includes changing a dimension of the object in response to entry of a value in an data field that is at least partly within the object.

### BRIEF DESCRIPTION OF THE DRAWINGS

FIG. 1 is a block diagram of a computer or processor system for editing a numeric chart.

FIG. 2. illustrates a representative numeric chart generated by a computer- or processor-implemented interactive graphics process and displayed by the system of FIG. 1.

FIGS. 3A-3C illustrate examples of editing the representative numeric chart of FIG. 3.

FIG. 4 illustrates examples of editing a representative pie chart.

FIG. 5 illustrates an example of editing a representative line chart.

FIG. 6 illustrates generation and use of a representative data table to present and edit values of variables represented by objects in the numeric chart of FIG. 3.

FIG. 7 is a flow chart illustrating an interactive graphics process with provision for editing a numeric chart.

### SPECIFICATION

A “graphics process” refers to a graphics program, process, method, or equivalent, and a “graphics processor” to a programmed computer, special purpose processor, networked process, or equivalent. Absent some indication to the contrary, use of the term “graphics process” alone to explain an example, an illustration, an embodiment, or a mode of use should be understood to also explain the example, illustration, embodiment, or mode of use with respect to a “graphics processor”. The principles to be presented in this specification are applicable to computer- and/or processor-generated graphics charts, preferably numeric charts including objects representing variables or parameters having values or magnitudes capable of being expressed in numbers. The specific examples used to illustrate these principles are not intended to, and should not, limit their scope to a particular kind of graphics chart.

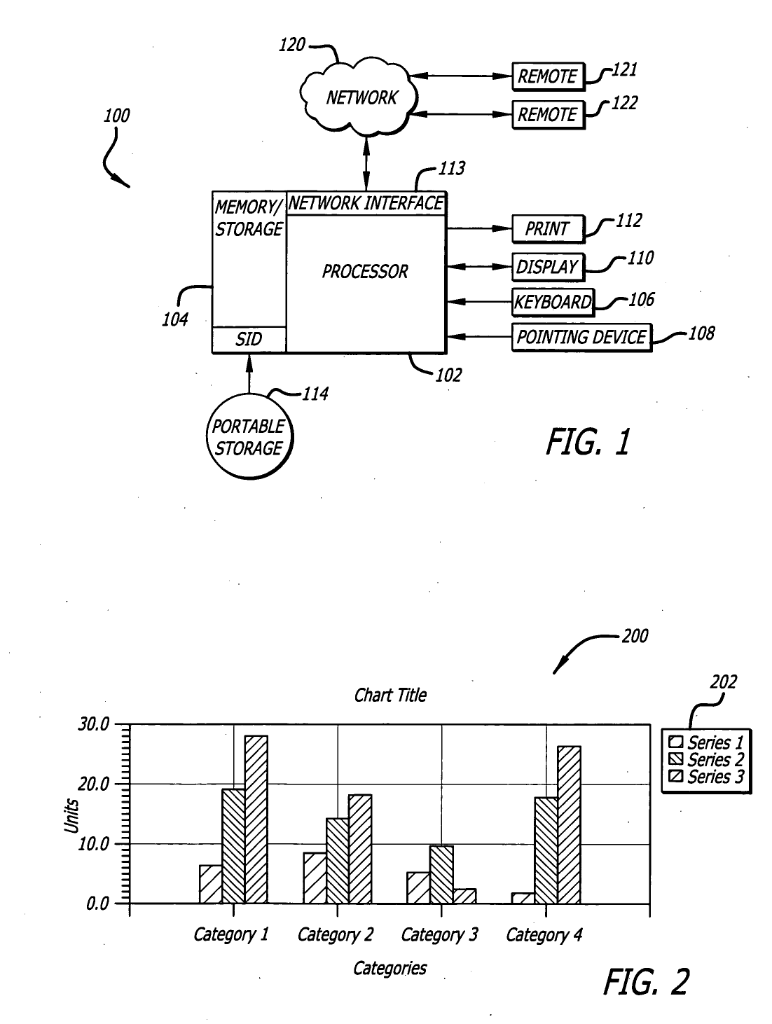

FIG. 1 illustrates an operational environment, and a computer system in which a graphics process may generate and modify numeric charts according to the principles explained below. The graphics process is interactive and thus enables a user to edit numeric charts by entering commands and initiating actions. The computer system 100 includes a programmed general or special purpose computer or processor 102 having memory and storage 104. The computer or processor 102 receives keystroke inputs from a keyboard or equivalent device 106 and receives other input from a manually-operated pointing device 108, such as a mouse. A display 110 provides a visual graphical user interface and a printer 112 generates printed output. A network interface 113 enables the computer system 100 to operate via a network 120, which may be local or global, with one or more remote entities 121, 122. The remote entities may be any one or more of other computers or processors, servers, websites, network nodes, and other equivalents. Graphics process programming may be stored, accessed, and executed solely at the computer system, or by way of a network to which the computer system 100 is connected. The computer or processor 102 may receive commands, including commands for editing graphics charts, generated by any one or more of keystrokes on the keyboard 106, drag-and-drop actions involving the pointing device 108, a cursor, and the display 110, and point-and-click actions involving the pointing device 108, a cursor, and the display 110. The computer or processor 102 generates visual output, including graphics charts and cursors, by display through the display device 110 and/or the printer 112.

In FIG. 1, the computer or processor 112 is enabled to execute a graphics process by programming received from a computer-readable storage medium which may be constituted of a portable storage device 114 such as a CD, DVD, memory stick, or other equivalent device, or by programming downloaded via network interface 113. So programmed, the computer or processor 102 constitutes a graphics processor and is enabled to practice a graphics process that generates and enables a user to edit graphics charts.

Editing of a computer- or processor-generated numeric chart involves entering numeric data that is plotted on a numeric chart directly into the chart in response to user commands, without having to use a means external to the chart such as a spread sheet or database program or a table separate from the chart. We have found that it is also beneficial to display in the chart a readout of the numeric data and/or to display in the chart a data entry field for entering the numeric data in conjunction with the execution of those commands in order to enhance the immediate understanding of user as to the effect of an editing action. Some of these actions may be or may include automatic actions, that is, self-initiated actions of a graphics process and/or a graphics processor that are not themselves literally required by user actions or user commands.

In FIG. 2, a representative example of a numeric chart is shown. The chart is a visible diagram, map, model, or schematic composed of chart objects (such as bars) that represent variables, and other chart objects (such as axes, labels, divisions) arranged to represent relationships among or between the variables. The exemplary chart is a bar chart 200 as it would be displayed in the system 100 of FIG. 1 with an interactive graphics process executing thereon. Preferably although not necessarily, the bar chart 200 is produced by editing a template or primitive initially provided by the graphics process. The bar chart 200 may include one or more categories, and each bar of a category may be assigned to a respective series. The series may be color coded according to a palette 202 with colors selected by a user. Thus, for example, series 1 bars may be blue, series 2 bars red, and series 3 bars green. The bar chart 200 includes vertical and horizontal axes, and the vertical axis is subdivided by ticks (divisions) corresponding to units. Each bar in the bar chart 200 represents a variable (or parameter) having a value (or magnitude) corresponding to some dimension of the bar, for example the height (or length) of the bar. In the example, the numeric value of the variable represented by a bar is indicated by the intersection of the upper edge of the bar with the vertical axis. Thus, a change in the numeric value of a bar is embodied as a change in its height (or length), and, conversely, changing the height (or length) of a bar changes its numeric value.

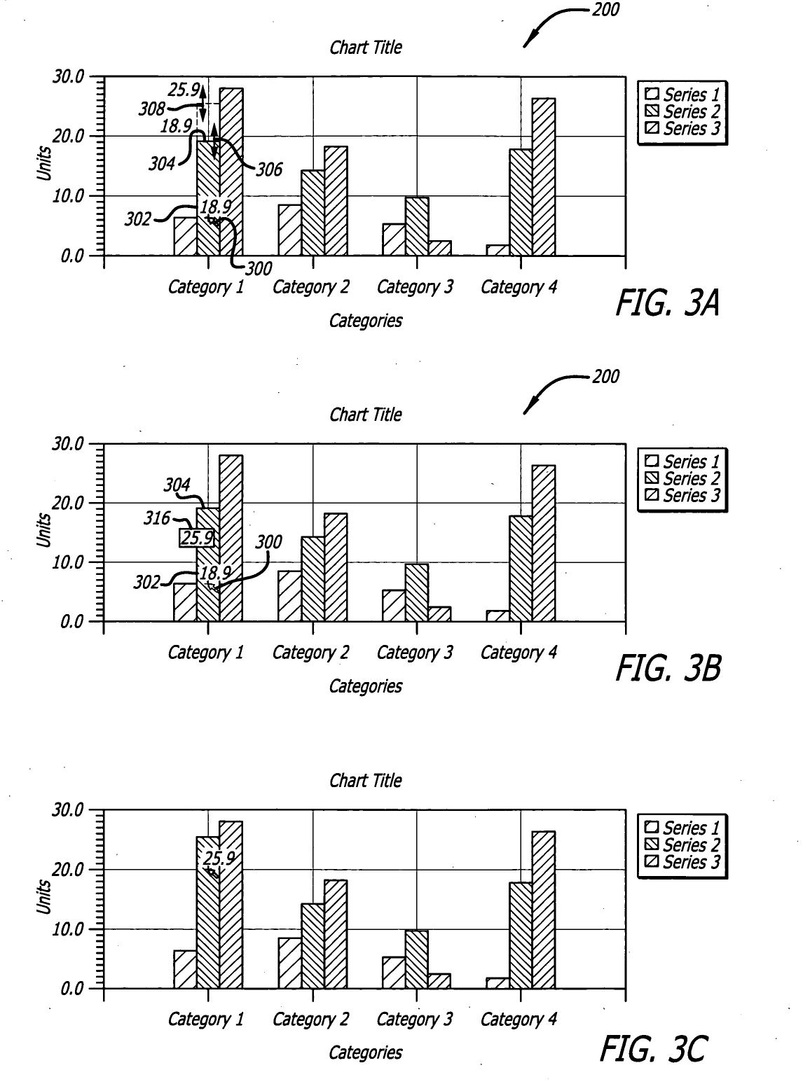

As per FIG. 3A, the bar chart 200 may be edited by use of a cursor 300 moved and actuated by a pointing device or a keyboard to change its numerical value. For example, to stretch the bar 302 the cursor 300 may be moved to the upper edge 304 of the bar 302 where it engages the edge (in the shape of the two-headed arrow 306) and the edge 304 may be dragged upwardly to a new location 308 above its initial location. The new location represents a larger value of the variable represented by the bar than that represented at the initial location. It should be evident that the numeric value of the bar 302 may be reduced by moving the edge downwardly, toward the horizontal axis, which shortens the bar 302.

One aspect of editing the bar 302 using the cursor 300 as shown in FIG. 3A is the provision of a readout of the numerical value that the interactive graphics process provides with the cursor. In this regard, when the cursor is moved to or within the bar 302, the numeric value of the variable represented by the bar is generated in the chart 200 with the cursor 300. As the cursor is moved from one bar to another, the readout changes to the numerical value of the bar entered. Preferably, the readout is positioned near the cursor, and moved with the cursor while the cursor is at or within the area of the bar 302. In the example of FIG. 3A, the numeric value readout is “18.9”, which corresponds with the numerical value at the location of the edge 304 in the chart 200. Presume now that the cursor is moved to the edge 304 where it is displayed as per the shape 306. Presume that the user enters a command (such as depression of the left button of a mouse, or a keystroke or other command) for the cursor 306 to engage and drag the edge 304 to the location 308. In the example of FIG. 3A, the readout of the numerical value of the bar 302 is maintained and moved with the cursor 306 as the edge 304 is dragged; in addition, the readout value is incremented continuously as the cursor 306 moves the edge to the location 308, where the readout value is shown as 25.9. In this aspect, a user is afforded with a high degree of precision in editing numeric charts that is not currently provided by interactive graphics programs. Now, the user can ascertain the precise magnitude of a changed value while editing a graph object without reference to a separate object, such as a chart, or visual estimation of the height of the bar with respect to a vertical axis.

Another aspect of editing the bar 302 using the cursor 300 as shown in FIG. 3B is the provision by the interactive graphics process of a data entry field through which a desired magnitude of the numerical value may be entered to increase or decrease the numeric value of the bar 302. In this regard, when the cursor is moved to or within the bar 302, the user may enter a command (such as a double click of the left button of a mouse, or a keystroke or other command) to which the interactive graphics process responds by ceasing display of the cursor and causing a data entry field 316 to be displayed with the bar 302 being edited. Preferably, the data entry field 316 is displayed in a convenient location with respect to the object being edited. For example in FIG. 3B, the field is displayed at least partly within the bar 302. When the data entry field 316 is displayed, the user may enter a value into the field by way of the keyboard. Following entry of the value, a command (such as a keystroke or other command) to change the numeric value of the bar 302 causes the interactive graphics process to change the display of the numeric chart 200 by moving the edge 304 to the location corresponding to the numeric value in the data entry field 316. Thus the values represented in a numeric chart can be edited in a manner that enables a user to precisely ascertain the effect of an editing sequence using without having to switch attention from the object being edited.

When either of the editing sequences shown in FIGS. 3A and 3B is completed, the cursor resumes the shape 300 and, if the cursor is kept at or within the edited bar, the readout value is maintained at the new numeric value. Thus, as per FIG. 3C, the readout is 25.9, the current numeric value of the bar 302.

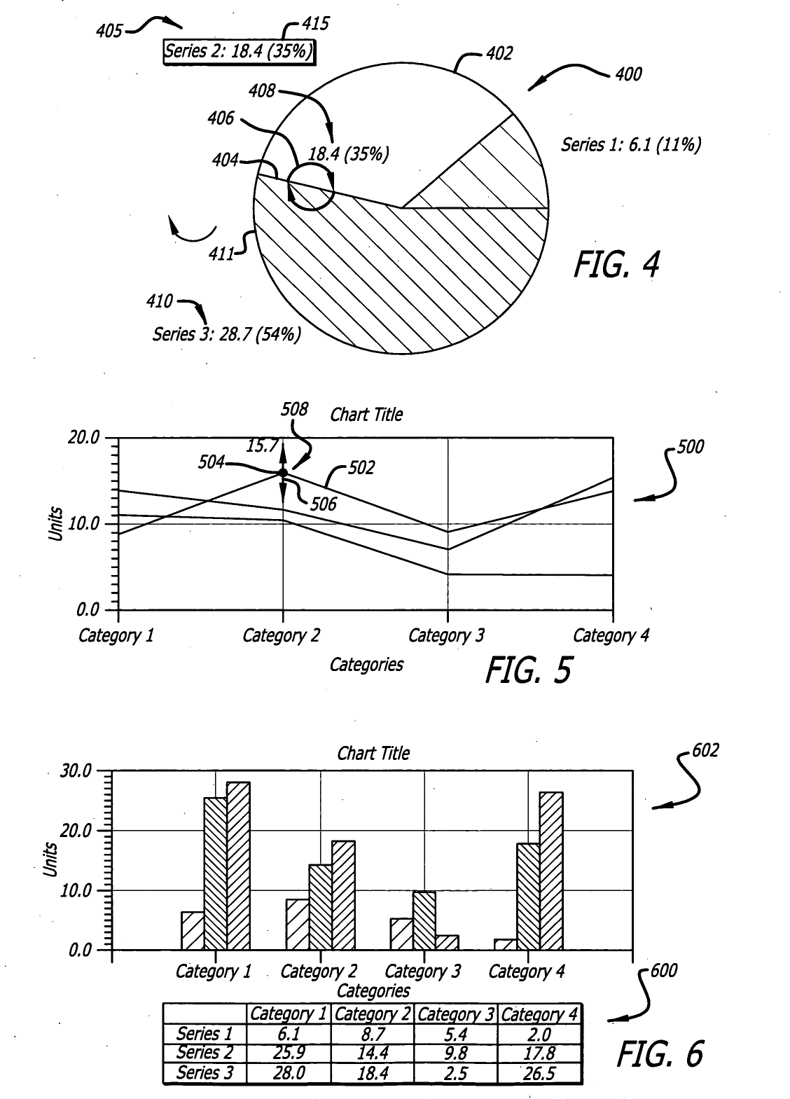

The interactive graphics process provides similar conveniences in editing other numeric charts. For example, as seen in FIG. 4, a pie chart 400 is displayed. Initially, the pie chart is displayed with color-coded wedges. A respective data field is displayed adjacent each wedge. For example, the wedge 402 has a data label 403 which contains a series identifier, a numerical value of the variable represented by the wedge, and a percentage of the pie chart area occupied by the wedge. The wedge 402 is edited by moving a cursor to an edge 404 of the wedge, where the cursor assumes the form 406. When the edge 404 is engaged by the cursor 406 (such as by depression of the left button of a mouse, or by entry of a keystroke or other command) and the edge may be dragged (swung) in either direction from its present to another location to increase or decrease the numerical value of the variable represented by the wedge 404. As the edge is engaged and dragged, a readout 408 of the numerical value of the variable represented by the wedge is displayed with the cursor 406 and the label 403 is deleted from the display. In this regard, when the cursor is moved to the edge 402, the numeric value of the variable (and the percentage of the area of the pie) represented by the wedge 404 is generated in the pie chart 400 with the cursor 406. As the cursor drags the edge 402 from one location to another, the readout is updated correspondingly with the changing numerical value of the wedge. Preferably, the readout is positioned near the cursor 406, and moved with the cursor while the cursor is engaged with the edge 402. At the same time, as the edge 404 is dragged, the readout 410 of the wedge 411 sharing the edge 464 is updated. Further, if the cursor is positioned within the wedge 402 and the wedge is selected (for example by a double click of a mouse button), a data entry field 415 is displayed with the data form the label 403, and the numerical value of the wedge 402 may be edited (for example by keystrokes). When the edited numerical value is entered, the change is apportioned between all other wedges in the pie chart and their data labels are appropriately changed.

In a further example, seen in FIG. 5, a line chart 500 is displayed. Initially, the line chart is displayed with color-coded lines. The line 502 is edited by moving a cursor to a point 504 of the line, where the cursor assumes the form 506. When the point 504 is engaged by the cursor 506 (such as by depression of the left button of a mouse, or by entry of a keystroke or other command) and the point may be dragged upwardly or downwardly from its present to another location to increase or decrease the numerical value of the variable represented by the line 502 at the point 504. As the point is engaged and dragged, a readout 508 of the numerical value of the variable represented by the line 502 at the point 504 is displayed with the cursor 506. In this regard, when the cursor is moved to the point 504, the numeric value of the variable represented by the point 504 is generated in the line chart 500 together with the cursor 506. As the cursor drags the point 504 from one location to another, the readout is updated correspondingly with the changing numerical value of the point. Preferably, the readout is positioned near the cursor 506, and moved with the cursor while the cursor is engaged with the point 504.

The interactive graphics process also provides the option of displaying a data table associated with a numeric chart and editing the chart by changing numeric values in the data table. The data table is displayed or not in response to user commands. For example, in FIG. 6, a data table 600 is displayed with a bar chart 602. Using the data table, a user can select a bar to edit by moving a cursor to the corresponding cell of the data table 600, entering a value in the table via keystrokes, and then entering a command (by a keystroke or mouse button, for example) to change the numerical value of the bar to the keyed-in value in the cell. In response, the length of the bar is edited to correspond to the numerical value in the cell. Also, while the table is displayed, a bar may be edited according to the procedures described above, and the resulting numerical value will be entered in the data table 600 in the cell of the table that corresponds to the bar. A data table may be displayed with and used to edit other numeric charts, including pie and line charts.

An interactive graphics program which enables a user to edit numeric charts according to the examples given above may be written in an appropriate language and compiled for execution in a computer or processor system such as the system illustrated in FIG. 1. In such a program, the actual data to be depicted by a numeric graph may be contained in point records. A point record may contain the numeric value associated with a particular variable. For example, it could be the average temperature in San Diego on a particular day, or it could be the revenue for a particular business unit of a corporation on a particular quarter. In a display, depending on the type of graph, each point may be depicted as a single bar in a bar chart, a point on a line chart, or a wedge of a pie chart. Each point record also contains information about its place in the overall chart. For example, if the chart depicts the annual revenue for three companies over the past five years, a particular point record would contain information that tells the program that the value it carries is for (for example) Microsoft's 2007 revenue. The program organizes this information and coordinates with other elements of the chart by use of the concepts of category and series. A series is normally a group of values all associated with a particular entity (corporation, for example). Categories are used to describe how each series changes over some interval (by year, for example). Using points in this manner and other abstractions, a wide and diverse range of information can be visually depicted. A point record has the following data structure.

Point Record

| | |
|---|---|
| typedef struct | |
| { | |
| int index; | //index of the object representing the point |
| UINT uniqueid; | //the id of the object representing the point |
| int dataid; | //id of the data element for this point |
| int seriesid; | //id of the column or series of data that |
| | this point belongs to |
| int categoryid; | //id of the category of data that this point |
| | belongs to |
| double value; | //the value of the point |
| RECT frame; | //rectangle of the shape |
| int tangle; | //value angle for the shape for pie charts |
| int explodeAmt; | //amount to explode this point (pies) |
| int wedgeStartTangle; | //wedge start angle for pie charts |
| SDImageFill imageFill; | //fill image |
| SIZE imgFillSize; | //size of the fill image |
| BOOL selected; | //currently selected |
| int flags; | //bit flags indicating whether a symbol |
| | should be used to fill etc and if tied to |
| | the third axis |
| SDStyle style; | //the style for drawing this point |
| double imagescale; | //number of units represented by one image |
| int imagestackfactor; | //number of images that are shown in a row |
| | before adding another row of images |
| | (default:1) |
| RECT imagerect; | //the rect of the image for one unit |
| RECT imagerectBottom; | //rect of the full rows of images (when using |
| | stacked images); bottom of a stretched image |
| RECT imagerectMiddle; | //rect of the middle of the image; partial row |
| | of full images (when using stacked images); |
| | stretchy center of stretched image |
| RECT imagerectTop; | //rect of the partial images. Remainder |
| | (<1 image) for stacked images; top part of |
| | stretched image |
| RECT imagePaintBounds; | //rect for use in defining paint bounds |
| | (span a single image over multiple points) |
| POINT footprint3d[4]; | //4 corners of the “face” of this point, |
| | in 3d (not persisted) |
| SDAxisLabel label; | //Label for value |
| } SDGraphPoint; | |

After a numeric chart is selected and displayed, interactive graphics program control of the editing functions described above in respect of FIGS. 3A-3B, 4, and 5 may be implemented according to a sequence of program instructions according to the following pseudo code representation, where the chartPoint value is determined with reference to the point record for the object being updated:

Program:

```
If chartPoint size
        Compute NewValue based on new size
        DataChanged = TRUE
If chartPoint direct text entry performed
        Interpret text into new NewValue
        DataChanged = TRUE
If DataChanged is TRUE
        Set chartPoint Value to NewValue
        If DataTable is linked
            Update DataTable representation of ChartPoint with
            NewValue
```

Thus, if a chart point size is changed by dragging an element of an object representing a variable, a new value is computed based upon the location to where the element is moved, and a DataChanged flag is set the relevant point record and the chart are updated with the new value. If a data entry field is used, the numeric text keyed into the field is interpreted to determine a new value, and the DataChanged flag is set. In both cases, when the DataChanged flag is set, the relevant point record and the chart are updated with the new value. If a data table has been generated in the display, the relevant table entry is updated with the new value.

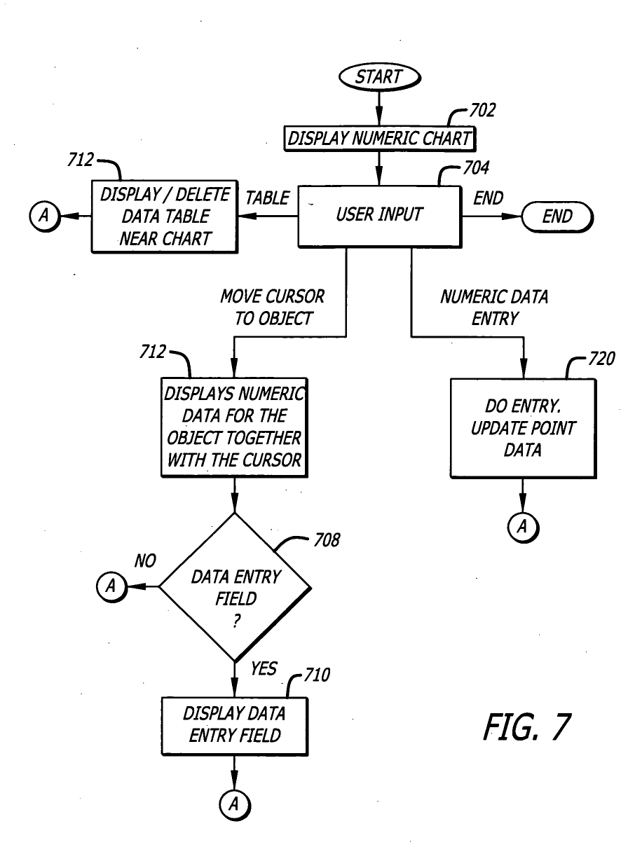

Using the flow chart of FIG. 7 as an example, operation of the interactive graphics process can be understood. When a user initiates display of a numeric chart, the process may offer a menu of chart templates from which the user chooses a particular type of numeric chart (bar, pie, line, and so on). The chosen template is displayed and the user initially edits the chart with respect to layout, colors, scales, categories, series, data, and initial numeric values for the objects of the chart that represent variables. Thus prepared, the numeric chart is displayed at block 702 and the process awaits a user input at block 704. When the cursor is moved into an object of the numeric chart (such as a bar in a bar chart), the object is highlighted and a readout of the numeric value of the represented variable is presented per block 706. If no command is entered to display a data entry field in the object where the cursor is positioned, the process follows the negative exit from decision 708 and control passes to block 704. On the other hand, if a command to display a data entry field, the process follows the positive exit from decision 708 and control passes to block 710 where the process causes a data entry field to be displayed in the object where the cursor is located. Control then passes to block 704.

In FIG. 7, when control is in block 704, the user may enter a command to display (or delete) a data table. Control passes to block 712 where the appropriate action is taken, and control then passes to block 704.

In FIG. 7, when control is in block 704 and a command is received to enter numerical data, the process, in block 720, determines the source of numerical data to be entered and updates the selected object according to the pseudo code illustration above. If the source is a data table, the numerical data is updated with reference to the table. After the update is made, control passes to block 704.

In FIG. 7, when control is in block 704, a user command to end the process causes control to stop editing the chart.

The scope of patent protection afforded the novel graphics process and graphics processor described and illustrated herein may suitably comprise, consist of, or consist essentially of the elements described. Further, the novel graphics process and graphics processor disclosed and illustrated herein may suitably be practiced in the absence of any element or step which is not specifically disclosed in the specification, illustrated in the drawings, and/or exemplified in the embodiments of this application.

Moreover, although an invention has been described with reference to particular embodiments, it should be understood that various modifications can be made without departing from the spirit of the invention. Accordingly, the invention is limited only by the following claims.

1. A computer-executed method for editing a numeric chart, comprising:
displaying a numeric chart having at least one object with a dimension representing a variable;
positioning a cursor in the object;
in response to positioning the cursor in the object, displaying a value of the variable at least partially within the object;
receiving a command to change the value; and,
in response to the command, changing the displayed value to the changed value and changing the dimension to correspond to the changed value.

2. The computer-executed method of claim 1, wherein the chart is a bar chart.

3. A computer-executed method for editing a numeric chart, comprising:
displaying a numeric chart having a plurality of objects representing variables;
positioning a cursor in an object of the plurality of objects; and,
displaying in the chart a readout of the value of the variable in response to positioning the cursor in the object.

4. The computer-executed method of claim 3, wherein displaying the readout includes displaying the readout near the location of the cursor.

5. The computer-executed method of claim 4, further comprising moving the readout in response to movement of the cursor in the object.

6. The computer-executed method of claim 5, further comprising:
moving the cursor to an edge of the object having a position that represents a value;
dragging the edge with the cursor from a first location representing a first value to a second location representing a second value; and
changing the value in the readout in response to dragging the edge.

7. The computer-executed method of claim 5, further comprising:
receiving a command to display values of the variables; and
in response to the command, displaying a table of the values near the chart.

8. The computer-executed method of claim 7, further comprising:
moving the cursor to an edge of the object having a position that represents a value;
dragging the edge with the cursor from a first location representing a first value to a second location representing a second value;
changing the value in the readout in response to dragging the edge; and, changing the value in the table in response to dropping the edge at the second location.

9. The computer-executed method of claim 5, wherein the chart is a bar chart.

10. The computer-executed method of claim 5, further comprising:
moving the cursor to the interior of the object;
dragging the object from a first location representing a first chart type to a second location representing a second chart type; and
automatically changing the type of the chart to the second type in response to dragging the object.

11. The computer-executed method of claim 10, wherein the first type is a bar chart and the second type is a stacked chart.

12. A computer-executed method for editing a numeric chart, comprising:
displaying a numeric chart having a plurality of objects representing variables;
positioning a cursor in an object of the plurality of objects; and,
in response to positioning the cursor in the object, displaying in the chart a field for entering a value of the variable.

13. The computer-executed method of claim 12, wherein displaying the field includes displaying the field at least partially in the object.

14. The computer-executed method of claim 12, further comprising:
receiving a value entered through a keyboard;
displaying the value in the field; and
changing a dimension of the object to represent the value.

15. The computer-executed method of claim 12, further comprising:
receiving a command to display values of the variables; and
in response to the command, displaying a table of the values near the chart.

16. The computer-executed method of claim 15, further comprising:
receiving a value entered through a keyboard;
displaying the value in the field;
changing a dimension of the object to represent the value; and,
changing the value in the table.

17. The computer-executed method of claim 12, wherein the chart is a bar chart.

18. The computer-executed method of claim 12, further comprising:
moving a cursor to the interior of the object;
dragging the object from a first location representing a first chart type to a second location representing a second chart type; and
changing the type of the chart to the second type in response to dragging the object.

19. The computer-executed method of claim 18, wherein the first type is a bar chart and the second type is a stacked chart.

20. The computer-executed method of claim 12, further comprising:
moving the cursor in the object; and,
in response to moving the cursor in the object, displaying a readout of the value of the variable represented by the object.
